(19) United States
(12) Patent Application Publication
(10) Pub. No.: US 2025/0044225 A1
(43) Pub. Date: Feb. 6, 2025

(54) Systems And Methods For Off-Axis Bubble Detection

(71) Applicant: Life Technologies Corporation, Carlsbad, CA (US)

(72) Inventors: Daniel Quigley, Fort Collins, CO (US); Daniel Nelson Fox, Fort Collins, CO (US); Keith Johnson, Fort Collins, CO (US)

(21) Appl. No.: 18/793,185

(22) Filed: Aug. 2, 2024

Related U.S. Application Data
(60) Provisional application No. 63/517,417, filed on Aug. 3, 2023.

(51) Int. Cl. G01N 21/53; G01N 1/20; G01N 21/05

(52) U.S. Cl. CPC G01N 21/53; G01N 1/20; G01N 21/05; G01N 2021/052; G01N 2201/06113

(57) ABSTRACT

A detection system that operates with reduced sample waste and dead volume, the system including: a module configured to introduce a sample spacer into a sample; at least one light source, wherein the light source illuminates the sample spacer and the sample, wherein illumination of the sample spacer produces scattered light; and a detection device configured to initiate acquisition of data related to the sample in response to scattered light detected by the detection device.

### RELATED APPLICATIONS

The present application claims priority to and the benefit of U.S. patent application No. 63/517,417, “Systems And Methods For Off-Axis Bubble Detection” (filed Aug. 3, 2023). All foregoing applications are incorporated herein by reference in their entireties for any and all purposes.

### TECHNICAL FIELD

The present disclosure relates to the field of optical sample analysis.

### BACKGROUND

Detection and characterization of particles, whether biological, organic, or inorganic, is essential in a broad range of fields, including clinical and environmental fields. Sample particles may be analyzed to determine various characteristics associated with the particles, which characteristics can include physical properties, optical properties, electronic properties, and the like. Samples can be expensive to acquire, time consuming to prepare, or otherwise difficult to gather in sufficient quantities to test. Improving sample accuracy and precision while minimizing sample waste is desirable, as is improving sample throughput.

Existing methods of particle characterization, however, have certain deficiencies, as existing methods often require tradeoffs between speed, accuracy, precision, and minimizing sample waste. As one example, increasing sample accuracy in a given method can result in reduced throughput speed.

In particular, operation of existing sample testing systems and methods often also entails a quantity of wasted sample, which wasted sample can be termed “dead volume.” Dead volume can result when the configuration of a system is such that when an amount of sample is passed through the system, data is acquired from only a portion of that amount of sample, thereby wasting some of the sample and also reducing the overall amount of data that is obtained from a given sample run. Given the time and effort needed to prepare sample for testing—which preparation can involve costly and time-consuming incubation steps—there is a long-felt need for approaches that operate using less dead volume, as such approaches would analyze a higher proportion of sample, thereby obtaining increased data from a given sample run and allowing for more robust conclusions to be drawn from those increased data.

Some attempts to address these shortcomings involve incorporating a spacer into a fluid sample to delineate between segments of sample. Introducing a spacer into a fluid can, however, have a negative impact on the sample collection process. For example, a bubble included in a fluid sample can produce inaccurate test results, as a bubble can interrupt a contiguous fluid sample and thereby present an impediment to collecting accurate data from the sample. For this reason, systems and methods known in the art are often constructed to minimize the possibility of the inclusion of a bubble, or other spacer, in a sample fluid. Accordingly, there is a long-felt need in the field for improved methods of sample detection.

### SUMMARY

In meeting the described challenges, the present disclosure provides, inter alia, the inclusion of a sample spacer, for example a bubble, in a sample detection system. As one example, a bubble can be incorporated into the leading edge of a sample, and a detection system may be configured to detect the bubble transiting the detection system. In this way, the detection system can determine, with a greater degree of accuracy than what is known in the art, when a sample is passing through a detection system, based at least in part on detecting the sample spacer.

Traditionally, bubbles in a sample are considered undesirable, as bubbles are considered detrimental to sample precision and accuracy. The disclosed technology, however, utilizes bubbles in a manner contrary to the conventional wisdom. Rather than seeking to eliminate bubbles as is done in existing approaches, the disclosed technology instead makes use of bubbles, as bubbles in the disclosed technology can be used as sample spacers, which sample spacers in turn can help improve sample precision and accuracy. Hence, intentional introduction of a sample spacer in a sample can be used to reduce dead volume and thereby increase the acquisition of useful data in a system.

In one aspect, the present disclosure provides a detection system, comprising: a module configured to introduce a sample spacer into a sample; at least one light source, wherein the light source illuminates the sample spacer and the sample, wherein illumination of the sample spacer produces scattered light; and a detection device configured to initiate acquisition of data related to the sample in response to scattered light associated with the sample spacer detected by the detection device.

Also provided is a system, comprising: a flow cell; a module configured to introduce a sample spacer into a sample; at least one light source, wherein the light source illuminates the sample spacer and the sample, wherein illumination of the sample spacer produces scattered light; and a detection device configured to initiate acquisition of data associated with the sample in response to scattered light associated with the sample spacer detected by the detection device.

Further provided is a method, comprising: detecting light scattered by a sample spacer entrained in a sample when the sample spacer is illuminated by a light source; and initiating acquisition of data associated with the sample in response to detecting the scattered light.

### BRIEF DESCRIPTION OF THE DRAWINGS

The drawings illustrate generally, by way of example, but not by way of limitation, various aspects discussed in the present document. In the drawings:

FIG. 1A provides an illustrative flow diagram prior to a sample spacer reaching an interrogation point.

FIG. 1B provides an illustrative flow diagram when a sample spacer is at an interrogation point.

FIG. 1C provides an illustrative flow diagram of a sample passing through an interrogation point.

FIG. 2 provides an illustrative non-limiting flow diagram of a light source passing to an in-line (or “on-axis”) sample detector and an off-line (or “off-axis”) sample spacer detector.

FIG. 3A provides an illustrative, non-limiting flow diagram when a sample spacer is at an interrogation point.

FIG. 3B provides an illustrative, non-limiting flow diagram of a sample passing through an interrogation point.

FIG. 4 provides an illustrative, non-limiting schematic of determining transit of a sample spacer through an interrogation point.

FIG. 5 provides a set of illustrative schematics describing the outcomes associated with a standard time gate versus a bubble detector trigger.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” can include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints. The endpoints of the ranges and any values disclosed herein are not limited to the precise range or value; they are sufficiently imprecise to include values approximating these ranges and/or values.

As used herein, approximating language can be applied to modify any quantitative representation that can vary without resulting in a change in the basic function to which it is related. Accordingly, a value modified by a term or terms, such as “about” and “substantially,” may not be limited to the precise value specified, in some cases. In at least some instances, the approximating language can correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” can refer to plus or minus 10% of the indicated number. For example, “about 10%” can indicate a range of 9% to 11%, and “about 1” can mean from 0.9-1.1. Other meanings of “about” can be apparent from the context, such as rounding off, so, for example “about 1” can also mean from 0.5 to 1.4. Further, the term “comprising” should be understood as having its open-ended meaning of “including,” but the term also includes the closed meaning of the term “consisting.” For example, a composition that comprises components A and B can be a composition that includes A, B, and other components, but can also be a composition made of A and B only. Any documents cited herein are incorporated by reference in their entireties for any and all purposes.

The present disclosure describes sample detection in general, though more particular examples are provided herein. The following principles may be incorporated in any suitable sample detection system, not simply limited to the examples provided.

In one aspect, the present disclosure generally discloses methods for introducing sample spacers to a sample. Sample spacers may comprise any number of materials. For example, a sample spacer can comprise an air bubble, a liquid bubble, a fluid immiscible with a sample fluid, a gas bubble, a solid plug, or other suitable sample spacer.

A sample can comprise any sample communicable through a detection system. For example, the sample can be gaseous, liquid, or solid, and can comprise particles therein. Sample particles can comprise biological cells, other biological material, inorganic particles, organic particles, or the like.

A sample spacer can be incorporated into the detection system at any number of locations. For example, the sample spacer can be incorporated into the detection system at a known distance ahead of the sample, at the leading edge of the sample, in the middle of the sample, at the trailing edge of the sample, or at a known distance trailing the sample.

A sample detection system can comprise any number of modules configured to detect a sample passed through the detection system. For example, a detection system can comprise a flow cytometer, which flow cytometer can be configured to pass a sample through an interrogation point.

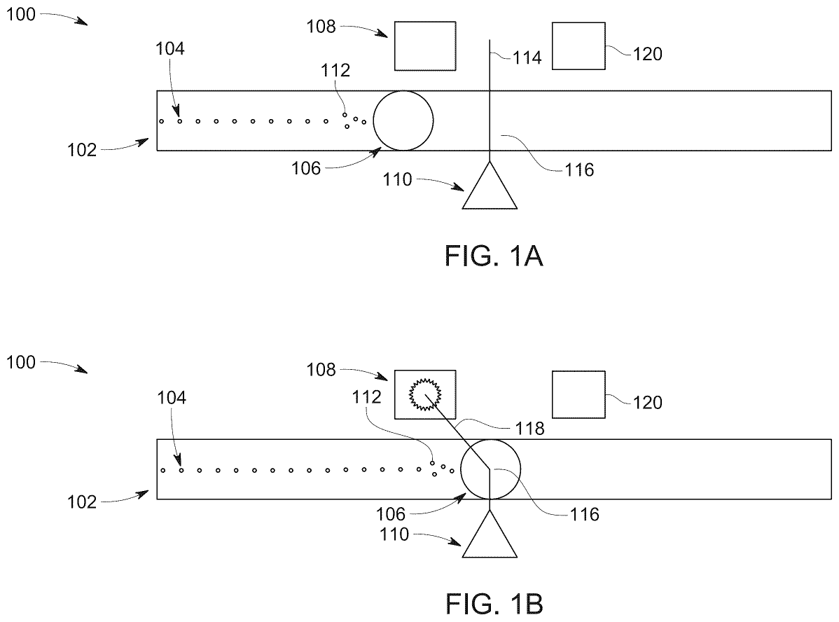

The sample detection system can comprise a detector to detect a sample passing through an interrogation point of the system. For example, FIGS. 1A-1C, 2, 3A, and 3B illustrate example sample detection systems at various stages of sample detection. FIGS. 1A-1C, 2, 3A, and 3B illustrate a flow cell. The flow cell can include a hollow portion configured to communicate a sample. For example, the flow cell can communicate one or more sample particles through the flow cell. For example, the sample shown in FIGS. 1A-1C, 2, 3A, and 3B can be configured to pass from an origin to an end of the flow cell. The sample can be introduced to the flow cell at an origin of the flow cell. The sample can comprise a sheath fluid, which sheath fluid can focus particles of the sample toward the center of the flow cell.

The sample can be configured to pass through an interrogation point of the flow cell. For example, the interrogation point can be configured to provide information about the sample in any number of ways. The detection system can be configured to pass light through the interrogation point. The light can be, for example laser light, visible light, infrared light, ultraviolet light, comprise x-rays, and the like. The detection system can be configured to examine the sample at the interrogation point using audio waves, optical detection methods, or the like.

The light source can comprise a laser. For example, the light source can comprise a 405 nm laser. The light source can comprise a 488 nm laser. The light source can comprise any wavelength laser known in the art.

FIG. 1A depicts a sample detection system 100 before a sample 104 reaches an interrogation point of the sample detection system 100. As shown, the sample detection system 100 includes a flow cell 102, with a plurality of sample particles of sample 104 and a sample spacer 106 communicating through the flow cell 102.

As shown in FIG. 1A, a sample spacer 106 is present at a leading edge of the sample 104. The sample spacer 106 can be directly leading the sample, or the sample spacer 106 can be substantially ahead of the sample. The sample spacer 106 can also be present at different locations with respect to the sample 104, for example within the stream of sample particles of the sample 104, trailing the sample 104, or substantially trailing the sample 104. The leading edge of the sample 104 can comprise a turbulent, or otherwise unstable or non-laminar portion 112. The unstable portion 112 may be caused due to the creation of the stream of sample particles of the sample 104; the unstable portion 112 may be caused due to the sheath fluid associated with the flow cell 102. The unstable portion 112 can be caused by the sample spacer 106. For example, the sample spacer 106 can comprise a bubble and the bubble can cause a disturbance within the sample. Accordingly, the leading portion of the sample may, in some instances, be unusable for data collection purposes. For example, data associated with the leading edge of the sample 104 may produce unreliable results.

The detection system 100 can be configured to detect the sample spacer 106. The light source 110 can communicate light, for example a laser or other light 114, to the flow cell 102. The light 114 from the light source 110 can then scatter in response to interacting with the sample spacer 106. The scattered light can be configured to interact with the sample spacer detector 108. In FIG. 1A, the sample spacer detector 108 may not detect any light 114 from the light source 110 because the sample spacer 106 is not transiting through the light 114 emitted from the light source 110.

The detection system 100 can be configured to begin acquisition of data based on the sample spacer detector 108 detecting the sample spacer 106. The detection system 100 in FIG. 1A can be configured to acquire no data when the sample spacer 106 has not been detected by the sample spacer detector 108.

The detection system 100 can comprise a light source 110. The light source can pass light 114, for example a laser, through the flow cell 102. One or more particular wavelengths of the light 114 from the light source 110 can be configured to scatter in response to interacting with one or more particles of the sample 104. In FIG. 1A, a sample detector may not detect light from the light source because the sample 104 is not transiting the light 114 emitting from the light source 110.

The detection system 100 can be configured to begin acquisition of data based on a delay associated with the sample spacer detector 108 detecting light 114. For example, the sample spacer detector 108 detecting light 114 can be an indication that the sample spacer 106 is transiting an interrogation point 116 of the flow cell 102. The sample spacer detector 108 can initiate acquisition of data based on a delay after detecting the light 114 scattered by the sample spacer 106. For example, the leading edge of the sample 104 may be unstable, turbulent, chaotic, or the like. Data acquired from the leading edge of the sample 104 may be unreliable or incorrect. Accordingly, the detection system 100 can delay sample data collection so as reduce or eliminate collection of data that may be influenced by the leading edge of the sample 104. The delay can comprise a set time period, a number of cycles of the detection system 100, a variable time period, or the delay can be based on a viscosity of a fluid in the flow cell 102. The delay can cause some sample 104 to be wasted without data collection. Such wasted sample 104, however, can be lesser than the amount of wasted sample associated with a typical flow cell. The delay can begin based on the detection of light 114 from the light source 110 by the sample spacer detector 108. The delay can be determined by, for example, a machine learning model.

FIG. 1B depicts a sample detection system 100 associated with a sample spacer 106 transiting an interrogation point 116 of the sample detection system 100. The detection system illustrates an example flow cell 102, with a plurality of sample particles of a sample 104 and a sample spacer 106 communicating through the flow cell 102.

As shown, FIG. 1B depicts the sample spacer 106 at a leading edge of the sample 104, with the sample spacer detector 108 detecting scattered light 118 scattered from the light source 110. The scattered light 118 can emit from the light source 110, pass partially through the flow cell 102, interact with the sample spacer 106, scatter partially, or wholly, toward the sample spacer detector 108, and the sample spacer detector 108 can detect the scattered light 118. For example, the sample spacer detector 108 can detect at least one photon associated with the scattered light 118 associated with the light source 110. The sample spacer detector 108 can, for example, comprise a single-photon avalanche diode (SPAD) configured to detect individual photons. The sample spacer detector 108 can comprise a photomultiplier tube (PMT). The sample spacer detector 108 can be configured to detect one or more wavelengths of light associated with one or more wavelengths of light emitted by the light source 110. The sample spacer detector 108 can detect scattered light 118 associated with entities other than the sample spacer 106. For example, a particle not associated with the sample spacer 106 may produce scattered light 118 from the light source 110, and the scattered light 118 produced by the particle not associated with the sample spacer 106 can be detected by the sample spacer detector 108. Therefore, it is desirable to provide a system for determining that scattered light 118 detected by the sample spacer detector 108 is indeed scattered light 118 associated with the sample spacer 106.

The system can determine whether scattered light is (or is not) associated with the sample spacer based on, for example, at least one of a duration of the detected scattered light, a quantity/brightness of the detected scattered light, or the like. As one example, a sample spacer may produce scattered light that is detected by the sample spacer detector over a greater length of time than other scattered light not associated with the sample spacer. For example, the sample spacer detector can detect scattered light associated with the sample spacer substantially continuously for from about hundreds of microseconds to multiple milliseconds. For example, the sample spacer detector may detect scattered light associated with the sample spacer substantially continuously from 500 microseconds to 10 milliseconds. However, the sample spacer detector may detect scattered light that is not associated with the sample spacer for a lesser length of time. For example, scattered light that not associated with the sample spacer may be detected at the sample spacer detector substantially continuously from about one microsecond to about 10 microseconds. In this way, the system can determine whether the detected scattered light is associated with the sample spacer based on a length of time over which the scattered light is detected.

The system can determine whether detected scattered light is associated with a sample spacer based on a magnitude or intensity of the scattered light detected by the sample spacer detector. For example, the sample spacer detector may detect scattered light associated with the sample spacer that is of a greater magnitude or intensity than the magnitude or intensity of scattered light that is not associated with the sample spacer. The sample spacer detector may detect both a duration of detected scattered light, as well as the magnitude or intensity of the scattered light, and based on a combination of the length of time the scattered light is detected and the magnitude or intensity of the detected scattered light, the system may determine whether the detected scattered light is associated with the sample spacer.

The detection system can be configured to begin acquisition of data based on the sample spacer detector detecting the sample spacer. The detection system in FIG. 1B can, for example, be configured to begin acquisition of data because the sample spacer 106 is detected by the sample spacer detector 108. The detection system in FIG. 1B can, for example, be configured to initiate a delay after detecting the sample spacer 106 before initiating acquisition of data. As mentioned elsewhere herein, the delay can be determined by a machine learning model. Such a machine learning model can be comprised in, for example, the acquisition train of a system according to the present disclosure.

The detection system can comprise a light source. The light source can pass light, for example a laser, through the flow cell. One or more wavelengths of light associated with the light from the light source can be configured to scatter in response to interacting with one or more particles of the sample. In FIG. 1B, the sample detector 120 does not detect light from the light source 110 that has interacted with the sample 104 because the sample has not yet transited the light emitting from the light source 110.

FIG. 1C describes a sample detection system 100 after a sample spacer, for example, sample spacer 106 transits through an interrogation point 116 of the sample detection system 100 and after a sample 104 reaches the interrogation point 116. The sample detection system 100 illustrates an example flow cell 102, with a plurality of sample particles of a sample 104 communicating through the flow cell 102. FIG. 1C does not show a sample spacer, for example sample spacer 106, at a leading edge of the sample 104; the sample spacer can have already transited the flow cell 102 interrogation point 116 and exited the sample detection area of the flow cell 102. As shown, FIG. 1C describes a flow of sample 104 communicating along the flow cell 102 in a stable manner; although the leading edge of the sample 104 may be turbulent, the rest of the sample 104 can be substantially stable. As shown, in FIG. 1C, the sample spacer detector 108 may not detect any light from the light source 110 because the sample spacer is not transiting the light emitted from the light source 110. In FIG. 1C, the sample spacer can have previously transited the interrogation point 116, and the sample spacer detector 108 can have previously detected the sample spacer.

The sample detection system 100 can be configured to begin acquisition of data based on the sample spacer detector 108 detecting a sample spacer. The sample detection system 100 in FIG. 1C can be configured to acquire data because the sample spacer previously transited the interrogation point 116, which caused light to be detected by the sample spacer detector 108.

As shown in FIG. 1C, the detection system can comprise a light source 110. The light source can pass light, for example a laser, through the flow cell. One or more wavelengths of light associated with the light from the light source may scatter in response to interacting with one or more particles of the sample 104. In FIG. 1C, the sample detector 120 can detect scattered light 122 or other emissions related to light from the light source 110 as the sample 104 is transiting the interrogation point 116 and interacting with the light emitting from the light source 110. The light can emit from the light source 110, pass partially through the flow cell 102, interact with the sample 104, scatter partially, or wholly, toward the sample detector 120, and the sample detector 120 can detect the scattered light 122. For example, the sample detector 120 can detect at least one photon associated with the scattered light 122 associated with the light source 110. For example, the sample detector 120 can comprise a single-photon avalanche diode (SPAD) configured to detect individual photons. The sample detector 120 can comprise a photomultiplier tube (PMT). The sample detector 120 can be configured to detect one or more wavelengths of light associated with one or more wavelengths of light emitted by the light source 110.

FIG. 1C also depicts the sample detection system 100 acquiring data associated with the sample 104. The sample detector 120 can output a signal in response to detecting one or more photons associated with the light source 110. The sample detector 120 can be configured to output the signal. The signal output by the sample detector 120 can be determined, processed, or manipulated to provide data associated with the sample 104.

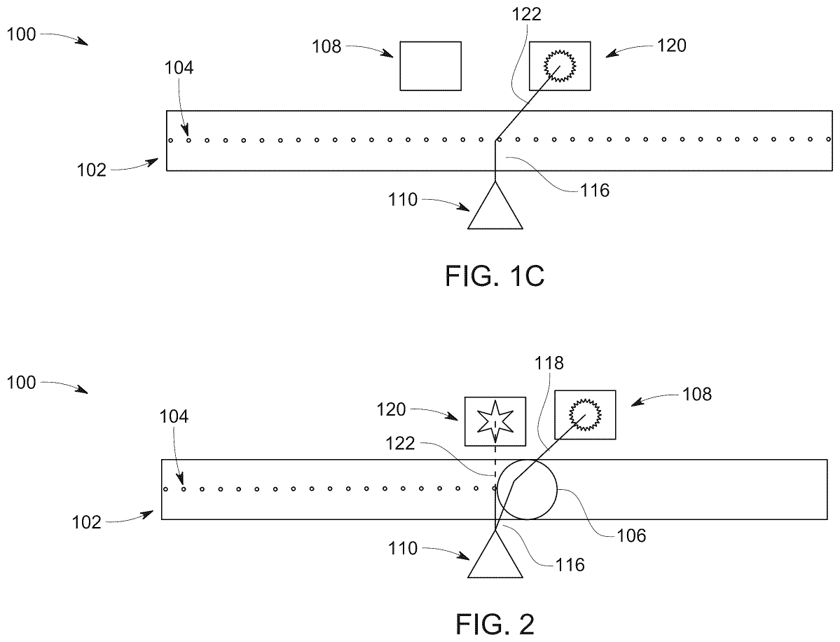

FIG. 2 depicts a sample detection system 100 having a sample 104 passing through the system. As shown, FIG. 2 describes a flow cell 102 through which a sample 104 and a sample spacer 106 can pass. The sample spacer 106 can be, for example, at a leading edge of a stream of sample particles of the sample 104. FIG. 2 depicts a light source 110 from which light can emit and illuminate a portion of the flow cell 102, such as an interrogation point 116 of the flow cell 102. The light can emit from the light source 110, pass through the flow cell 102, and exit the other side of the flow cell 102. Some or all of the light emitted from the light source 110 can be collected by a detector. For example, light passing through the flow cell 102 can be detected by a sample detector 120 or a sample spacer detector 108; light collected by a sample detector 120 or sample spacer detector 108 can be light that has interacted with or is scattered by a sample 104 or a sample spacer 106.

As shown, the system in FIG. 2 describes a sample detector 120 and a sample spacer detector 108. The sample detector 120 can be configured to detect scattered light 122, which light can be light scattered by a sample particle that passes through the interrogation point 116 of the flow cell 102 and interacts with light emitted from the light source 110. As shown, the sample spacer detector 108 can be configured to detect light scattered by a sample spacer 106 that passes through the interrogation point 116 of the flow cell 102 and interacts with light emitted from the light source 110. As shown, the sample spacer 106 can be in an on-line configuration, in which the sample detector 120 is in line with the light emitting from the light source 110, although this is not a requirement. Such an on-line configuration can be achieved by having the sample detector 120 in register with the light emitted from the light source 110. The sample spacer detector 108 may be in an off-line configuration, in which the sample spacer detector 108 is out of line with or off-axis from light emitted from the light source 110, although this is not a requirement. Such an out of line configuration can be achieved by having the sample spacer detector 108 positioned in a way that the sample spacer detector 108 is not in register with light emitted from the light source 110. In an embodiment, scattered light 118 scattered by the sample spacer 106 is detected by the sample spacer detector 108. That detection then initiates data acquisition by the sample detector 120, which sample detector 120 then detects scattered light 122 scattered by a sample 104 passing through the interrogation point 104. As shown in FIG. 2, the sample detector 120 can be on-axis relative to the light source 110, and the sample spacer detector 108 can be off-axis relative to the light source.

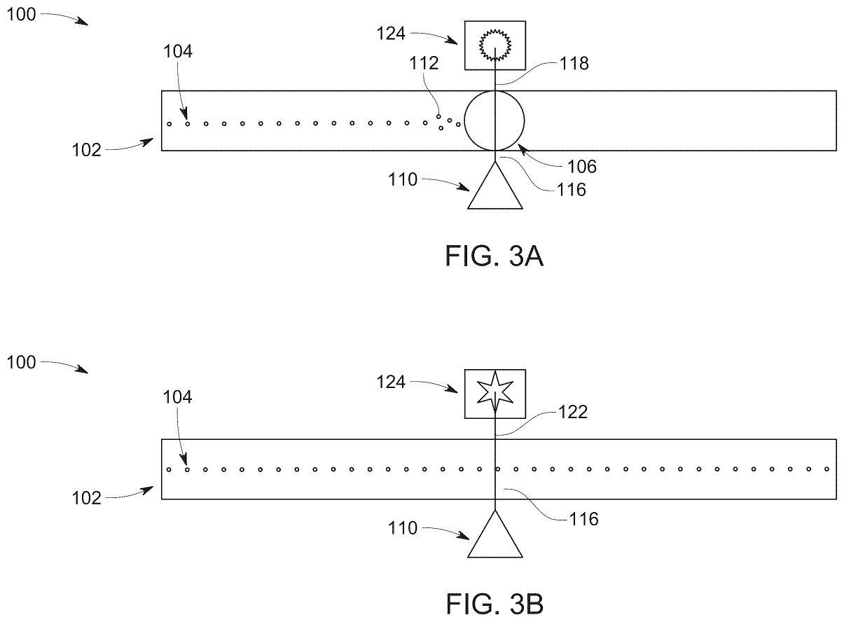

FIG. 3A depicts a sample detection system 100 associated with a sample spacer 106 transiting an interrogation point 116 of a flow cell 102 of the sample detection system 100. The sample detection system 100 illustrates an example flow cell 102, with a plurality of sample particles 104 and a sample spacer 106 communicating through the flow cell 102, as well as a sample and sample spacer detector 124, configured to detect at least one sample spacer 106 and at least one sample 104, such as a sample particle.

As shown, FIG. 3A depicts the sample spacer 106 at a leading edge of the sample 104, with the sample and sample spacer detector 124 detecting light scattered from the light source 110. The light can emit from the light source 110, pass partially through the flow cell 102, interact with the sample spacer 106, scatter partially, or wholly, and the sample and sample spacer detector 124 can detect the scattered light from the sample spacer 106. For example, the sample and sample spacer detector 124 can detect at least one photon associated with the scattered light associated with the light source 110. The sample and sample spacer detector 124 can, for example, comprise a single-photon avalanche diode (SPAD) configured to detect individual photons. The sample and sample spacer detector 124 can comprise a photomultiplier tube (PMT). The sample and sample spacer detector 124 can be configured to detect one or more wavelengths of light associated with one or more wavelengths of light emitted by the light source 110. For example, the sample and sample spacer detector 124 may be configured to detect a particular wavelength or wavelengths of light associated with scattered light 118 scattered by the sample spacer 106. For example, the sample spacer 106 may scatter light associated with a particular wavelength or particular wavelengths of light, and the sample and sample spacer detector 124 may be able to determine a sample spacer 106 is transiting an interrogation point 116 of the flow cell 102 based on the sample and sample spacer detector 124 detecting a particular wavelength of scattered light 118 associated with the sample spacer 106. The sample and sample spacer detector 124 can detect scattered light 118 associated with entities other than the sample spacer 106. For example, a particle not associated with the sample spacer may produce scattered light 118 from the light source 110, and the scattered light 118 produced by the particle not associated with the sample spacer 106 can be detected by the sample and sample spacer detector 124. Therefore, it is desirable to provide a system for determining that scattered light detected by the sample and sample spacer detector 124 is indeed scattered light associated with the sample spacer 106.

The system can determine whether scattered light is (or is not) associated with the sample spacer 106 based on, for example, at least one of a duration of the detected scattered light, a quantity/brightness of the detected scattered light, or the like. As one example, a sample spacer 106 may produce scattered light that is detected by the sample and sample spacer detector 124 over a greater length of time than other scattered light not associated with the sample spacer 106. For example, the sample and sample spacer detector 124 can detect scattered light associated with the sample spacer 106 substantially continuously for from about hundreds of microseconds to multiple milliseconds. For example, the sample and sample spacer detector 124 may detect scattered light 118 associated with the sample spacer 106 substantially continuously from 500 microseconds to 10 milliseconds. However, the sample and sample spacer detector 124 may detect scattered light that is not associated with the sample spacer 106 for a lesser length of time. For example, scattered light that not associated with the sample spacer 106 may be detected at the sample and sample spacer detector 124 substantially continuously from about one microsecond to about 10 microseconds. In this way, the system can determine whether the detected scattered light 118 is associated with the sample spacer 106 based on a length of time over which the scattered light 118 is detected.

The system can determine whether detected scattered light is associated with a sample spacer 106 based on a magnitude or intensity of the scattered light detected by the sample and sample spacer detector 124. For example, the sample and sample spacer detector 124 may detect scattered light associated with the sample spacer 106 that is of a greater magnitude or intensity than the magnitude or intensity of scattered light that is not associated with the sample spacer 106. The sample and sample spacer detector 124 may detect both a duration of detected scattered light, as well as the magnitude or intensity of the scattered light, and based on a combination of the length of time the scattered light is detected and the magnitude or intensity of the detected scattered light, the system may determine whether the detected scattered light is associated with the sample spacer 106.

The sample detection system 100 can be configured to begin acquisition of data based on the sample and sample spacer detector 124 detecting the sample spacer 106. The sample detection system 100 in FIG. 3A can, for example, be configured to begin acquisition of data because the sample spacer 106 is detected by the sample and sample spacer detector 124. The sample detection system 100 in FIG. 3A can, for example, be configured to initiate a delay after detecting the sample spacer 106 before initiating acquisition of data. As mentioned elsewhere herein, the delay can be determined by a machine learning model. Such a machine learning model can be comprised in, for example, the acquisition train of a system according to the present disclosure.

The light source 110 can also pass light through the flow cell 102 at one or more wavelengths that do not substantially interact with the sample spacer 106. The light source 110 can pass light, for example a laser, through the flow cell 102. The light from the light source 110 can be configured to scatter in response to interacting with one or more particles of the sample 104. In FIG. 3A, the sample and sample detector 124 does not detect light from the light source 110 that has interacted with the sample 104 because the sample 104 has not yet transited the light emitting from the light source 110.

FIG. 3B describes a sample detection system 100 after a sample spacer 106 reaches an interrogation point 116 of the sample detection system 100 and after a sample 104 reaches the interrogation point 116 of the sample detection system 100. The sample detection system 100 illustrates an example flow cell 102, with a plurality of sample particles 104 and a sample spacer communicating through the flow cell. FIG. 3B does not show a sample spacer at a leading edge of the sample 104; the sample spacer can have already transited the flow cell 102 interrogation point 116 and exited the sample detection area of the flow cell 102. As shown, FIG. 3B describes a flow of sample 104 communicating along the flow cell 102 in a stable manner; although the leading edge of the sample 102 may be turbulent, the rest of the sample 104 can be substantially stable. As shown, in FIG. 3B, the sample and sample spacer detector 124 may not detect any light from the light source 110 associated with the sample spacer because the sample spacer is not transiting the light emitted from the light source 110. In FIG. 3B, the sample spacer may have previously transited the interrogation point 116, and the sample and sample spacer detector 124 may have previously detected the sample spacer.

The sample detection system 100 can be configured to begin acquisition of data based on the sample and sample spacer detector 124 detecting the sample spacer. The sample detection system 100 in FIG. 3B can be configured to acquire data because the sample spacer previously transited the interrogation point 116 and previously registered with the sample and sample spacer detector 124.

As shown in FIG. 3B, the sample detection system 100 can comprise a light source 110. The light source 110 can pass light, for example a laser, through the flow cell 102. The light from the light source 110 may scatter in response to interacting with one or more particles of the sample 104. In particular, the light source 110 may be configured to pass light of one or more wavelengths through the flow cell 102, and particular wavelengths of the light passed through the flow cell 102 may scatter in response to coming in contact with the sample 104. The particular wavelengths of light may scatter from the sample 104, and the sample and sample spacer detector 124 may detect the scattered light 122 associated with the sample 104 from the light source 110. In FIG. 3B, the sample and sample spacer detector 124 can detect scattered light 122 or other emissions related to light from the light source 110 as the sample is transiting the interrogation point 116 and interacting with the light emitting from the light source 110. The light can emit from the light source 110, pass partially through the flow cell 102, interact with the sample 104, scatter partially, or wholly, and the sample and sample spacer detector 124 can detect the scattered light 122 associated with the sample 104. For example, the sample and sample spacer detector 124 can detect at least one photon associated with the scattered light 122 associated with the light source 110. For example, the sample and sample spacer detector 124 can comprise a single-photon avalanche diode (SPAD) configured to detect individual photons. The sample and sample spacer detector 124 can comprise a photomultiplier tube (PMT). The sample and sample spacer detector 124 can be configured to detect one or more wavelengths of light associated with one or more wavelengths of light emitted by the light source 110 associated with one or more wavelengths of the light that scatter when interacting with the sample 104.

FIG. 3B also depicts the sample detection system 100 acquiring data associated with the sample 104. The sample and sample spacer detector 124 can output a signal in response to detecting one or more photons associated with the light source 110 associated with the sample 104. The sample and sample spacer detector 124 can be configured to output the signal. The signal output by the sample and sample spacer detector 124 can be determined, processed, or manipulated to provide data associated with the sample 104.

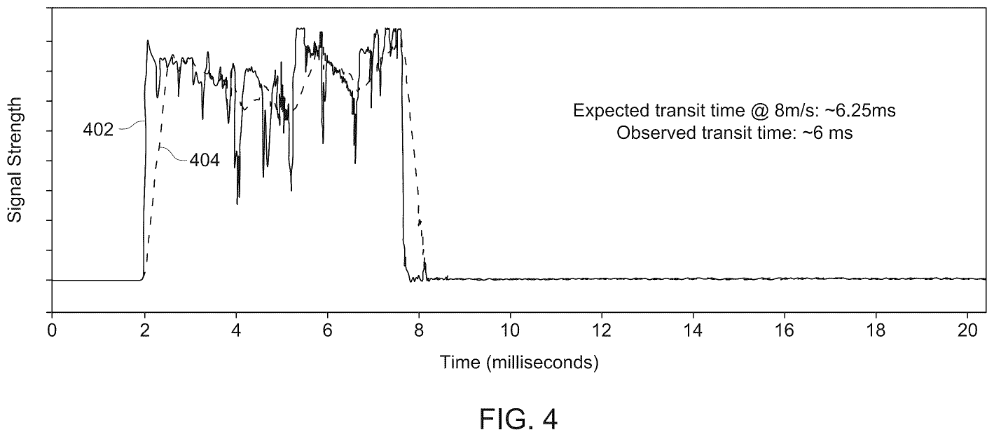

FIG. 4 provides an illustrative signal produced by a sample spacer detected by a sample spacer detector, for example as described in FIGS. 1B, 2, and 3A. FIG. 4 presents time on the x-axis, for example a time in milliseconds. The y-axis comprises a value associated with light detected by the sample spacer detector. For example, the y-axis can comprise a pseudo raw signal output by the sample spacer detector. The pseudo raw signal can represent an output signal of the sample spacer detector. For example, the pseudo raw signal can represent a value associated with the light detected by the sample spacer detector based on a detection time.

For example, the pseudo raw signal can begin after the start time at 0 ms; as shown, the pseudo raw signal increases above zero at approximately 2 ms. The start of the time may substantially coincide with the introduction of the sample spacer to the flow cell or to the sample. FIG. 4 depicts the sample spacer detector being configured to receive light associated with detecting a sample spacer bubble, showing a bubble reaching the sample spacer detector at approximately 2 ms.

The sample spacer detector can detect scattered light associated with the sample spacer for a period of time associated with the sample spacer transiting the interrogation point associated with the sample spacer detector. For example, the sample spacer can comprise a specified volume, and the volume of the sample spacer can take a specified quantity of time to transit the interrogation point associated with the sample spacer detector.

FIG. 4 also illustrates non-limiting data associated with a sample spacer substantially transiting the interrogation point associated with the sample spacer detector, which transiting takes around 6 ms. As shown in FIG. 4, the sample spacer detector begins to detect scattered light associated with the sample spacer at around 2 ms, with detection of scattered light associated with the sample spacer ending at around 8 ms.

As shown in FIG. 4, a pseudo raw signal can include numerous peaks and valleys, with multiple valleys that are less than half the value of the highest peaks associated with line 402. For example, the sample spacer can comprise a bubble, and the bubble may not be uniformly distributed in a single bubble while communicating through the flow cell. For example, the bubble may contain impurities, or the bubble may break into multiple bubbles as the bubble communicates through the flow cell. Accordingly, the scattered light detected by the sample spacer detector may not be uniform during the time period associated with the sample spacer transiting the interrogation point associated with the sample spacer detector, and the value of the pseudo raw signal 402 associated with the detection of the scattered light associated with the sample spacer may comprise a high variance.

While the pseudo raw signal 402 may generally indicate a bubble is being detected by the sample spacer detector, one or more of the valleys in the pseudo raw signal 402 may fall below a threshold associated with detection of a bubble. It is, however, desirable to accurately determine when the bubble begins and ends its transit of the sample spacer detector detection point.

The pseudo raw signal 402 associated with the detected scattered light from the sample spacer can be normalized based on one or more criteria. For example, the system can apply a debounce approach to remove outlier signals, such as extremely high or low signals occurring in less than a threshold period of time. Additionally, the normalization, or smoothing, can be applied to the pseudo raw signal 402 to smoothed representation of the bubble transiting the sample spacer detector detection point. The smoothed line 404 shown in FIG. 4 thus represents a smoothed version of the pseudo raw signal 402. The smoothed signal 404 can provide a more stable view of the sample spacer detection system detecting light, for example detecting light associated with a bubble.

The detection system can begin acquisition of sample data after detecting a bubble by the sample spacer detector. In some embodiments, the threshold for determining a bubble is detected by the sample spacer detector can be based on a threshold output signal.

For example, the pseudo raw signal 402 may comprise too many peaks or too many valleys, or the pseudo raw signal 402 may comprise an individual peak too high or an individual valley too low for a bubble detection algorithm associated with the detection system to determine a bubble is transiting the sample spacer detector. Thus, a smoothed signal 404 can provide the bubble detection algorithm with data that can better indicate whether a bubble did transit through the flow cell.

As an example, the bubble detection algorithm can require an output signal to exceed a threshold signal value for a period of time. Any one of the valleys shown in the pseudo raw signal 402 can cause the pseudo raw signal 402 to dip below the threshold bubble detection algorithm cutoff, and the bubble detection algorithm may incorrectly determine no bubble transited through the flow cell. Alternatively, the smoothed signal 404 may effectively eliminate the highest peaks and lowest valleys of the pseudo raw signal 402, such that the smoothed signal 404 does not dip below the threshold required by the bubble detection algorithm to determine a bubble is present in the flow cell. Accordingly, the smoothed signal 404 may cause the bubble detection algorithm to accurately account for bubbles transiting the flow cell.

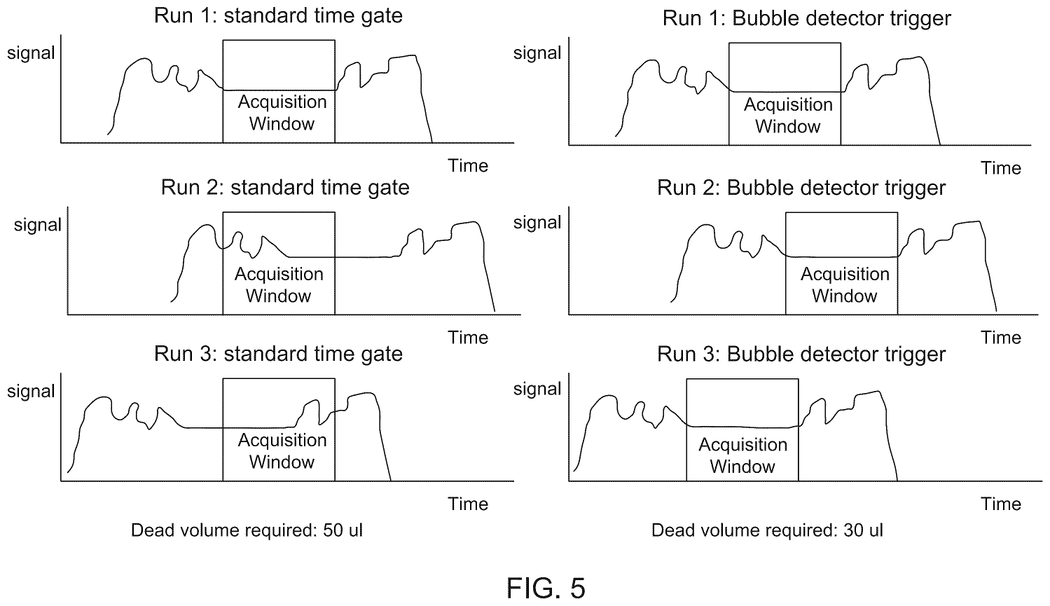

FIG. 5 depicts several illustrative sample signal outputs. The three runs associated with the “standard time gate” are associated with methods currently known in the art, while the three “bubble detector trigger” runs are related to the system disclosed herein.

In particular, the standard time gate runs are all associated with a set acquisition window. For example, a user of the detection system can input a delay associated with an acquisition window, begin running a sample through the detection system, and the detection system can acquire sample data based on the delay programmed by the user. For example, a user may determine that acquisition of data should begin 5 ms after beginning to communicate the sample through the flow cell. However, due to any number of factors, two separate runs of the same sample material may transit the flow cell at different rates, and the sample may thus transit an interrogation point associated with the detection system at different times. The delay can be determined by, for example, a machine learning model.

In the case of the standard time gate, the detection system is not sensitive to any changes in the rate or time at which the sample is transiting the interrogation point of the flow cell. Therefore, as shown in Runs 1-3 of the standard time gate method, the acquisition window begins at exactly the same time. Thus, while Run 1 depicts a situation where the acquisition window is open for a period of time perfectly aligning with the ideal time to acquire sample data, Runs 2 and 3 depict acquisition windows that are open at times that return inconsistent, or even incorrect, sample data. For example, Run 2 depicts a sample that may take longer to reach equilibrium in the interrogation point of the flow cell. Thus, when the acquisition window begins the sample is not stable and the sample signal collected by the detection system begins with a faulty signal. Moreover, the acquisition window closes too early and valid data from the sample is not collected at all.

Run 3 depicts the opposite problem. The sample reaches equilibrium at the interrogation point earlier than the user of the detection system planned for, so some of the valid data associated with the sample is not collected. Then, because the acquisition window opens too late, the acquisition window stays open for too long and the last portion of the acquisition window is spent collecting faulty or noisy data. In the examples depicted in Runs 2 and 3 of the standard time gate, at least part of the sample data is undesirable. Therefore, standard time gated methods typically build in additional buffer time at the beginning and end of an acquisition window to reduce the amount of undesirable data collected. However, additional buffer time leads to a shorter acquisition window and an inability to capture the entire desired portion of the sample data. Therefore, some of the desired portion of the sample data is wasted, known as dead volume. With samples that are difficult to prepare or expensive to acquire, wasting sample as dead volume can be costly to both time and resources.

On the other hand, Runs 1-3 associated with the “bubble detector trigger” provide examples of detection runs shown with variable acquisition windows. Rather than suffer the same downsides mentioned above with respect to the standard time gate method, the acquisition windows in the bubble detector trigger can be adjusted based on each sample to provide an acquisition that captures more of the good volume of the sample data and leaves out more of the unstable volume of the sample data.

An example bubble detector trigger is described, for example, in FIGS. 1A, 1B, 1C, 2, 3A, and 3B. The sample spacer detector can determine when a bubble transits an interrogation point of a flow cell, and the detection system can begin acquisition of data at a time determined based on the detection of the bubble. Therefore, if a sample communicates through the flow cell faster than anticipated, the bubble will be detected earlier than anticipated and the acquisition window may begin earlier than anticipated. Likewise, if a sample communicates through the flow cell slower than anticipated, the bubble will be detected later than anticipated and the acquisition window may begin later than anticipated. In both scenarios the bubble detector trigger provides a more accurate method for determining when to begin acquisition of sample data. Further, more accurately capturing the desired portion of the sample data leads to capturing less of the undesired portions of the sample data. In this way, more accurately avoiding capturing undesirable portions of the sample data allows for the detection system to reduce the quantity of dead volume built into the sample detection system, reducing sample waste. For example, the standard time gate may require a dead volume of 50 μl to capture a suitable quantity of desired sample data, whereas the bubble detector trigger method may require a smaller dead volume of 30 μl to capture the same suitable quantity of desired sample data.

### Aspects

The following Aspects are illustrative only and do not limit the scope of the present disclosure or the appended claims. Any part or parts of any one or more Aspects can be combined with any part or parts of any one or more other Aspects.

Aspect 1. A detection system, comprising: a module configured to introduce a sample spacer into a sample; at least one light source, wherein the light source illuminates the sample spacer and the sample, wherein illumination of the sample spacer produces scattered light; and a detection device configured to initiate acquisition of data related to the sample in response to scattered light associated with the sample spacer detected by the detection device.

Aspect 2. The detection system of Aspect 1, further comprising an acquisition train configured to: receive a signal from the detection device and, in response to the signal, begin acquisition of data associated with the sample.

Aspect 3. The detection system of any one of Aspects 1-2, wherein the acquisition train is further configured to begin acquisition of data following the signal attaining a specified value.

Aspect 4. The detection system of any one of Aspects 1-3, wherein the acquisition train is further configured to begin acquisition of data at a first time following the signal attaining the specified value.

Aspect 5. The detection system any one of Aspects 1-4, wherein the first time comprises a delay, the delay optionally based at least in part on at least one of a volume of the sample or a flow rate at which the sample is communicated through a flow cell.

Aspect 6. The detection system of any one of Aspects 1-5, wherein the acquisition train is further configured to process the signal to generate a processed signal and begin the acquisition of data following the processed signal differing from a specified value for a specified time period.

Aspect 7. The detection system of any one of Aspects 1-6, wherein the acquisition train is further configured to process the signal to generate a processed signal and begin the acquisition of data at a first time following the processed signal differing from the specified value for the specified time period.

Aspect 8. The detection system of any one of Aspects 1-7, wherein the first time comprises a delay, the delay optionally based at least in part on at least one of a volume of the sample or a flow rate at which the sample is communicated through a flow cell.

Aspect 9. The detection system of any one of Aspects 1-8, wherein the acquisition train is further configured to cease the acquisition of data in response to at least one of a volume of the sample analyzed, a length of time, a number of events, or receipt from the detection device of a signal associated with scattered light from an additional sample spacer.

Aspect 10. The detection system of any one of Aspects 1-9, wherein the sample spacer comprises a volume of from 0.5 μl to 4.0 μl.

Aspect 11. The detection system of any one of Aspects 1-10, wherein the sample spacer comprises a volume of from 0.5 μl to 2 μl.

Aspect 12. The detection system of any one of Aspects 1-11, wherein the light source comprises at least one of a 405 nm or a 488 nm laser.

Aspect 13. The detection system of any one of Aspects 1-12, wherein the module comprises at least one of a valve, a pump, an injector, a cavitation apparatus, a heat source, or a gas permeable membrane.

Aspect 14. The detection system of any one of Aspects 1-13, wherein the detection device comprises at least one sample spacer detector configured to detect the scattered light associated with the sample spacer, and wherein the detection device further comprises at least one sample detector configured to acquire data related to the sample.

Aspect 15. The detection system of any one of Aspects 1-14, wherein the detection device comprises one detection device, wherein the one detection device is configured to detect the scattered light associated with the sample spacer and further configured to acquire data related to the sample.

Aspect 16. A system, comprising: a flow cell; a module configured to introduce a sample spacer into a sample; at least one light source, wherein the light source illuminates the sample spacer and the sample, wherein illumination of the sample spacer produces scattered light; and a detection device configured to initiate acquisition of data associated with the sample in response to scattered light associated with the sample spacer detected by the detection device.

Aspect 17. The system of Aspect 16, further comprising an acquisition train configured to: receive a signal from the detection device and, in response to the signal, begin acquisition of data associated with the sample.

Aspect 18. The system of any one of Aspects 16-17, wherein the acquisition train is further configured to begin acquisition of data following the signal attaining a specified value.

Aspect 19. The system of any one of Aspects 16-18, wherein the acquisition train is further configured to begin acquisition of data at a first time following the signal attaining the specified value.

Aspect 20. The system of any one of Aspects 16-19, wherein the first time comprises a delay, the delay optionally based at least in part on at least one of a volume of the sample or a flow rate at which the sample is communicated through the flow cell.

Aspect 21. The system of any one of Aspects 16-20, wherein the acquisition train is further configured to process the signal to generate a processed signal and begin the acquisition of data following the processed signal differing from a specified value for a specified time period.

Aspect 22. The system of any one of Aspects 16-21, wherein the acquisition train is further configured to process the signal to generate a processed signal and begin the acquisition of data at the first time following the processed signal differing from a specified value for a specified time period.

Aspect 23. The system of any one of Aspects 16-22, wherein the first time comprises a delay, the delay optionally based at least in part on at least one of a volume of the sample or a flow rate at which the sample is communicated through the flow cell.

Aspect 24. The system of any one of Aspects 16-23, wherein the acquisition train is further configured to cease the acquisition of data in response to at least one of a volume of the sample analyzed, a length of time, a number of events, or receipt from the detection device of a signal associated with scattered light from an additional sample spacer.

Aspect 25. The system of any one of Aspects 16-24, wherein the sample spacer comprises a volume of from 0.5 μl to 4.0 μl.

Aspect 26. The system of any one of Aspects 16-25, wherein the sample spacer comprises a volume of from 0.5 μl to 2.0 μl.

Aspect 27. The system of any one of Aspects 16-26, wherein the light source comprises at least one of a 405 nm laser or a 488 nm laser.

Aspect 28. The system of any one of Aspects 16-27, wherein the module comprises at least one of a valve, a pump, an injector, a cavitation apparatus, a heat source, or a gas permeable membrane.

Aspect 29. The system of any one of Aspects 16-28, wherein the detection device comprises at least one sample spacer detector configured to detect the scattered light associated with the sample spacer, and wherein the detection device further comprises at least one sample detector configured to acquire data related to the sample.

Aspect 30. The system of any one of Aspects 16-29, wherein the detection device comprises one detection device, wherein the one detection device is configured to detect the scattered light associated with the sample spacer and further configured to acquire data related to the sample.

Aspect 31. A method, comprising: detecting light scattered by a sample spacer entrained in a sample when the sample spacer is illuminated by a light source; and initiating acquisition of data associated with the sample in response to detecting the scattered light. The method can be performed by, for example, a system according to any one of Aspects 1-30.

Aspect 32. The method of Aspect 31, further comprising: receiving a signal associated with detecting the light; and in response to receiving the signal, beginning the acquisition of data associated with the sample.

Aspect 33. The method of any one of Aspects 31-32, wherein the beginning the acquisition of data further comprises beginning the acquisition of data following the signal reaching a specified value.

Aspect 34. The method of any one of Aspects 31-33, wherein the beginning the acquisition of data further comprises beginning the acquisition of data at the first time following the signal reaching the specified value.

Aspect 35. The method of any one of Aspects 31-34, wherein the first time comprises a delay, the delay optionally based at least in part on at least one of a volume of the sample or a flow rate at which the sample is communicated through a flow cell.

Aspect 36. The method of any one of Aspects 31-35, wherein the beginning the acquisition of data further comprises: generating, from the signal, a processed signal; and beginning the acquisition of data following the processed signal differing from a specified value for a specified time period.

Aspect 37. The method of any one of Aspects 31-36, wherein the beginning the acquisition of data further comprises: generating, from the signal, the processed signal; and beginning the acquisition of data at the first time following the processed signal differing from the specified value for the specified time period.

Aspect 38. The method of any one of Aspects 31-37, wherein the first time comprises a delay, the delay optionally based at least in part on at least one of a volume of the sample or a flow rate at which the sample is communicated through a flow cell.

Aspect 39. The method of any one of Aspects 31-38, further comprising ceasing acquisition of data in response to at least one of a volume of the sample analyzed, a length of time, a number of events, or receipt of a signal associated with an additional sample spacer.

Aspect 40. The method of any one of Aspects 31-39, wherein the sample spacer comprises a volume of from 0.5 μl to 4.0 μl.

Aspect 41. The method of any one of Aspects 31-40, wherein the sample spacer comprises a volume of from 0.5 μl to 2.0 μl.

Aspect 42. The method of any one of Aspects 31-41, wherein the light source comprises at least one of a 405 nm or a 488 nm laser.

Aspect 43. The method of any one of Aspects 31-42, further comprising introducing the sample spacer to the sample.

Aspect 44. The method of any one of Aspects 31-43, wherein the sample spacer is introduced to the sample by at least one of a valve, a pump, an injector, a cavitation apparatus, a heat source, or a gas permeable membrane.

What is claimed:

1. A detection system, comprising:
a module configured to introduce a sample spacer into a sample;
at least one light source, wherein the light source illuminates the sample spacer and the sample, wherein illumination of the sample spacer produces scattered light; and
a detection device configured to initiate acquisition of data related to the sample in response to scattered light associated with the sample spacer detected by the detection device.

2. The detection system of claim 1, further comprising an acquisition train configured to:
receive a signal from the detection device and, in response to the signal, begin acquisition of data associated with the sample.

3. The detection system of claim 2, wherein the acquisition train is further configured to begin acquisition of data following the signal attaining a specified value.

4. The detection system of claim 3, wherein the acquisition train is further configured to begin acquisition of data at a first time following the signal attaining the specified value, wherein the first time comprises a delay, the delay optionally based at least in part on at least one of a volume of the sample or a flow rate at which the sample is communicated through a flow cell.

5. The detection system of claim 2, wherein the acquisition train is further configured to process the signal to generate a processed signal and begin the acquisition of data following the processed signal differing from a specified value for a specified time period.

6. The detection system of claim 5, wherein the acquisition train is further configured to process the signal to generate a processed signal and begin the acquisition of data at a first time following the processed signal differing from the specified value for the specified time period.

7. The detection system of claim 6, wherein the first time comprises a delay, the delay optionally based at least in part on at least one of a volume of the sample or a flow rate at which the sample is communicated through a flow cell.

8. The detection system of claim 2, wherein the acquisition train is further configured to cease the acquisition of data in response to at least one of a volume of the sample analyzed, a length of time, a number of events, or receipt from the detection device of a signal associated with scattered light from an additional sample spacer.

9. The detection system of claim 1, wherein the sample spacer comprises a volume of from 0.5 μl to 4.0 μl.

10. The detection system of claim 1, wherein the light source comprises at least one of a 405 nm or a 488 nm laser.

11. The detection system of claim 1, wherein the module comprises at least one of a valve, a pump, an injector, a cavitation apparatus, a heat source, or a gas permeable membrane.

12. The detection system of claim 1, wherein the detection device comprises at least one sample spacer detector configured to detect the scattered light associated with the sample spacer, and wherein the detection device further comprises at least one sample detector configured to acquire data related to the sample.

13. The detection system of claim 1, wherein the detection device comprises one detection device, wherein the one detection device is configured to detect the scattered light associated with the sample spacer and further configured to acquire data related to the sample.

14. A system, comprising:
a flow cell;
a module configured to introduce a sample spacer into a sample;
at least one light source, wherein the light source illuminates the sample spacer and the sample, wherein illumination of the sample spacer produces scattered light; and
a detection device configured to initiate acquisition of data associated with the sample in response to scattered light associated with the sample spacer detected by the detection device.

15. The system of claim 14, further comprising an acquisition train configured to:
receive a signal from the detection device and, in response to the signal, begin acquisition of data associated with the sample.

16. The system of claim 15, wherein the acquisition train is further configured to begin acquisition of data at a first time following the signal attaining a specified value.

17. The system of claim 16, wherein the first time comprises a delay, the delay optionally based at least in part on at least one of a volume of the sample or a flow rate at which the sample is communicated through the flow cell.

18. The system of claim 15, wherein the acquisition train is further configured to process the signal to generate a processed signal and begin the acquisition of data following the processed signal differing from a specified value for a specified time period.

19. The system of claim 15, wherein the acquisition train is further configured to cease the acquisition of data in response to at least one of a volume of the sample analyzed, a length of time, a number of events, or receipt from the detection device of a signal associated with scattered light from an additional sample spacer.

20. The system of claim 14, wherein the sample spacer comprises a volume of from 0.5 μl to 4.0 μl.
